(19) United States
(12) Patent Application Publication
(10) Pub. No.: US 2022/0407727 A1
(43) Pub. Date: Dec. 22, 2022

(54) DEVICE, VEHICLE, AND METHOD FOR MINING A BLOCK

(71) Applicant: Hüseyin UYSAL, Berlin (DE)

(72) Inventor: Hüseyin UYSAL, Berlin (DE)

(21) Appl. No.: 17/777,582

(22) PCT Filed: Nov. 16, 2020
(86) PCT No.: PCT/EP2020/082225

§ 371 Date: May 17, 2022

(30) Foreign Application Priority Data
Nov. 19, 2019 (DE) 20 2019 106 440.4

(51) Int. Cl. H04L 9/00; H04L 9/32

(52) U.S. Cl. CPC H04L 9/50; H04L 9/3239

(57) ABSTRACT

The invention relates to a device for mining, comprising a computing unit for the calculation of hash values for a character string by means of a cryptographic hash function, the computing unit being configured to calculate the hash values at a hash rate of at least 109 H/s and/or a hash calculation efficiency of at least 107 H/J. The device includes an electrical power supply to which the computing unit can be electrically connected, and a frame to which the computing unit and the electrical power supply are fixedly connected. The device is designed for the transport of an additional payload.

The present invention relates to devices for mining a block, in particular, a block in a blockchain, e.g., for use in a crypto-currency system, such as the bitcoin mining system, and to associated methods.

A blockchain is a continuously expandable list of data records, which are referred to as “blocks”, wherein the blocks are linked to one another by means of cryptographic methods. Each of these blocks contains a cryptographically secure hash (hereafter also referred to as scatter value and checksum) of the preceding block. In addition to the respective data, e.g., one or more transaction data, the blocks also typically contain a respective time stamp. New blocks of the blockchain are generated in a computing-intensive process, which is referred to as so-called mining. These newly-generated blocks are subsequently added to the blockchain and distributed via the network to other nodes or participants (subscribers). In return for the computing power provided, the participants, hereafter also called miner, that generates a valid block receives a counter-value in the form of a fee and/or a portion of a newly-created coin of a crypto-currency. The calculation/validation of new blocks can also be distributed to several miners, which, if successful, are proportionally remunerated.

Due to their design, blockchains are comparatively resistant to subsequent changes in the data stored therein. For use as a distributed (perpetual) ledger, a blockchain is typically managed by a network of participating (computing) nodes (hereafter also referred to as compute nodes), in particular a corresponding peer-to-peer network, which adhere to a common protocol for communication between the nodes and the validation of new blocks. The data in a particular block cannot be changed retroactively without all subsequent blocks likewise being changed, which requires approval by the network majority or the majority of the typically high computing power in the network.

In addition, it may be provided that the difficulty of calculating/validating new blocks depends on the total computing power of the participants (miners) or nodes in the network, e.g. in that the hash for a new block must be smaller than a predefined target value, as is provided for in the Bitcoin system, for example. This leads to a large number of hashes having to be calculated.

Due to the high computing power required, which may increase over time, the calculation/validation is often carried out by special (computer) farms in countries with favourable electricity prices such as China, Estonia or Bulgaria.

Even there, the structure and/or operation of these farms is, however, complex or associated with further considerable costs. For instance, the power supply for several miners/nodes requires comparatively thick and expensive cables. In addition, large and strong transformers and a very powerful and correspondingly expensive ventilation systems must be installed for cooling. In addition, extensive fire protection measures may be required for special buildings to be newly constructed, where applicable. Furthermore, a sufficiently fast Internet connection with a high data rate is to be provided for the plurality of miners. In addition, the farm needs a comparatively large amount of space, and insurance and, where applicable, rent must typically be paid.

In view of the above, the present invention proposes a device for mining according to claim 1, a vehicle according to claim 16, a system for mining a block according to claim 26, a vehicle fleet according to claim 27, and an installation kit for a vehicle according to claim 31.

According to one embodiment, a device for mining, in particular for mining a block of a blockchain comprises a computing unit for calculating hash values of a character string by means of a cryptographic hash function, wherein the computing unit is configured to calculate the hash values at a hash rate of at least 10⁹ H/s (hashes per second) and/or a hash calculation efficiency of at least 10⁷ H/J (hashes per Joule (utility power supplied to the computing unit)); an electrical power supply, e.g., an electrical energy store, which can be electrically connected to the computing unit; and a frame, in particular, a chassis to which the computing unit and the electrical power supply are fixedly connected. In addition, the device is designed for the transport of an additional payload.

Typically, the device is even primarily used for the transport of the additional payload. In any case, in addition to the fuel costs, the operation of the computing unit ultimately does not incur any further additional ancillary costs, such as the above-mentioned insurance, rents, etc., which already have been incurred for the transport or have to be assigned thereto (commercially). Accordingly, the mining —typically carried out during transport—of an installed computing unit makes it possible to achieve additional revenues or even additional profit (dependent substantially upon the fluctuating fuel prices and market values of the crypto-currency) of currently at least €50, at least €100, or even at least €200 per month (in the case of a (cost-dependent) daily operation of at least 8 h, 12 h, or 20 h) for the crypto-currency mining. The author of this publication was able to prove this by driving a passenger car equipped with a corresponding computing unit based on a commercially available so-called hashboard. Such an addition to revenue is amortized relatively quickly and is therefore of particular interest to operators of vehicle fleets, but also to individual companies in the transport sector.

Since the installed computing unit, including a, typically, additionally installed cooling system, requires only comparatively little space (typically, a maximum of a few liters, e.g., a maximum of 4 L or even only a maximum of 2 L), the comfort of passengers or the volume of a cargo area is hardly impaired or even not impaired at all.

The device is typically a motorized vehicle.

In other words, a vehicle, according to one embodiment, comprises a chassis and a computing unit, which is fixedly connected to the chassis, for calculating a cryptographic hash function, having a hash rate of at least 10⁹ H/s and/or a hash calculation efficiency of at least 10⁷ H/J.

Typically, the computing unit is specially designed and/or even optimized for calculating the cryptographic hash function.

This means in particular that a typically highly optimised (mathematical) algorithm designed to calculate the cryptographic hash function is implemented in the computing unit.

In particular, the computing unit can have or consist of a hashboard, a (correspondingly programmed) FPGA (Field Programmable Gate Array), and/or an ASIC (“Application-Specific Integrated Circuit”). However, the computing unit can also have (at least) one CPU and/or (at least) one GPU, e.g., when the computing efficiency is less important than in rail vehicles. However, even then, the use of FPGA(s) is particularly advantageous due to their comparatively low power demand and (re)programmability.

The computing unit can even have two or even more FPGA's and/or two or even more ASIC's. In particular, the computing unit can have one, two, or more hashboards, which each have one, two, or even more FPGA's and/or one, two, or even more ASIC's.

The computing unit can have either only several FPGA's or only several ASIC's.

However, the computing unit can also have at least one FPGA and at least one ASIC.

While ASIC's may have a higher hash calculation efficiency in comparison to FPGA's, but frequently have a high power demand, the typically energy-efficient FPGA's are more flexible, since they can be reprogrammed.

Particularly in embodiments in which the computing unit has several FPGA's and/or ASIC's as computing subunits, it can be provided that two or even more of the respective computing subunits (chips) be configured to execute the same algorithm for calculating the cryptographic hash function.

Alternatively and or additionally, it can be provided that at least one of the computing subunits be configured to execute a further algorithm for calculating a further cryptographic hash function.

This makes it possible, for example, to use the computing unit as a function of current boundary conditions (in particular, the prices as well as the difficulty) for the mining of various crypto-currencies.

Thus, the computing unit can have, for example, several FPGA's and/or ASIC's, which can each execute a different algorithm.

In addition, it can also be provided that at least one of the computing subunits be configured to execute a respective other algorithm for calculating the cryptographic hash function or the further cryptographic hash function.

The selection of the algorithm or of the computing subunit(s) is typically based upon the expected revenues or the expected profit (each per unit time).

In the case of the use of the computing unit for digging crypto-currencies, the revenue as a product results from the current degree of difficulty, the hash rate, and the market value of the crypto-currency.

For calculating the expected profit, the additional fuel costs that result from the current fuel costs and the expected energy consumption of the computing unit (per unit time) are to be subtracted.

For reasons of simplicity, the further features of the device for mining and of the vehicle are explained in detail below only with respect to vehicles. However, it is understood that the device for mining can also have the explained further features.

In particular, the vehicle (the device for mining) may be a rail vehicle or a motor vehicle, in particular a truck, a bus, or a passenger car, in particular, a delivery vehicle or a taxi or a vehicle operated as a taxi, e.g., an Uber vehicle. In addition, the vehicle may be a rental vehicle or a car-sharing vehicle.

The electrical power supply of the computing unit can take place via an on-board power supply, typically, a vehicle battery of the vehicle. Since the computing unit, at least in passenger cars, can typically have a power demand that is not insignificant in comparison to the on-board power supply, the computing unit is preferably supplied via the vehicle battery and not directly via the on-board power supply. The electrical power supply of the computing unit(s) can also be provided directly via the on-board electrical system in other vehicles in which the on-board electrical system is very robust or designed for a comparatively high electrical power of the consumers, such as in rail vehicles or ships.

The vehicle can, in particular, be a vehicle with a powerful battery (rechargeable battery or secondary battery), e.g., a hybrid vehicle or an electric vehicle, but also a vehicle that is reliably supplied with external electrical power, e.g., a suburban railway, an underground railway, a tramway, or another rail vehicle or road vehicle supplied with electrical power, e.g., a trolley bus.

For safety reasons, the computing unit can or is typically electrically connected via a circuit breaker to the electrical power supply.

Depending upon the type of electrical power supply of the vehicle, a power converter can alternatively or additionally be provided between the electrical power supply of the computing unit. The power converter can in particular be a rectifier and/or a DC voltage converter.

Typically, the power converter is arranged in a first part of the vehicle, in particular in an engine compartment of the vehicle, and/or the computing unit is arranged in a second part, spaced apart from the first part, of the vehicle, in particular in a storage space, e.g., in a trunk or underneath the trunk. This way, there is no waste heat generated by the power converter in the second part, which could otherwise contribute to an undesired temperature increase in the second part of the vehicle.

While, in a passenger car, only one computing unit for calculating a cryptographic function is typically installed, rail vehicles, trucks, and buses can also be equipped with two or even more corresponding computing units. Accordingly, higher additional revenues can be achieved.

According to one embodiment, a vehicle fleet, in particular a bus fleet, a truck fleet, a car fleet, in particular a taxi fleet or a rail vehicle fleet, comprises several transport vehicles, each of which has a built-in computing unit, in particular firmly arranged in and/or on the transport vehicle, for calculating hash values of a character string by means of a cryptographic hash function, and an electrical power supply that can be electrically connected to the computing unit, in particular several corresponding vehicles as described herein. The vehicle fleet can be a rental vehicle fleet or a car sharing fleet.

According to a further embodiment, a system for mining a block, in particular a block for a blockchain, comprises several connectable computing nodes for calculating hash values of a character string by means of a cryptographic hash function, wherein the computing nodes are configured in the connected state to exchange data by means of a network protocol, and wherein at least one of the computing nodes of a device for mining or a vehicle is as described herein.

The hash rate can be at least 10¹⁰ H/s, at least 10¹¹ H/s, or even at least 10¹² H/s. In addition, the hash calculation efficiency can be at least 10⁸ H/J or even 10⁹ H/J. Accordingly, higher revenues can be achieved by the mining.

The hash rates and hash calculation efficiencies specified herein typically relate to hash values with a length of 256 bits or an integer multiple thereof. In particular, the hash function used may be an SHA hash function (“Secure Hash Algorithm”), typically an SHA-2 hash function.

In addition, the specified values for the hash rates and hash calculation efficiencies may refer to the mining of crypto-currencies, such as bitcoin. In this context, it is pointed out that the hash rate and the nominal power of commercial computing units for crypto-mining are usually specified by the manufacturer, from which the (nominal) hash calculation efficiency can also be easily calculated.

The computing unit can be connected directly, but also indirectly, e.g., via a body of the vehicle, to the chassis—typically, by means of one or more screw connections.

In addition, the chassis is typically designed for an additional load of at least 100 kg, at least 500 kg, or even at least 1,500 kg.

According to one development, a cooling system for the computing unit is provided. In particular, the computing unit can be provided with a passive cooling system, e.g., a cooling element.

Typically, the cooling system has an active cooling system.

The active cooling system can have a liquid cooling system, in particular a water cooling system—or can be designed as such a cooling system.

The liquid cooling system typically comprises a heat exchanger, a coolant pump, and/or a fan or several fans. In particular, the liquid cooling system or the heat exchanger can have or be provided with a radiator having several fans, e.g., 2, 4, or 6 fans, and/or can be designed as a (compact) (active) cooling module.

The fan or the radiator can be connected via a vibration damper to the body or the chassis. As a result, the transmission of, where applicable, audible vibrations into a passenger compartment of the vehicle can be reliably suppressed.

The cooling capacity of the cooling system is typically adapted to the nominal power of the computing unit.

In particular, the liquid cooling system can have a (controllable maximum) cooling capacity of at least 100 W, at least 200 W, or even at least 500 W or 700 W.

Particularly in vehicles designed as passenger cars, the active cooling system for the computing unit is typically fluidically separated from a cooling unit for the engine—in particular, an internal combustion engine (diesel, gasoline, or gas engine)—or an air-conditioning unit for a vehicle interior. The separate structure of the cooling system or cooling circuits also enables easier installation in the vehicle.

Particularly for vehicles with a powerful cooling system or air-conditioning system, e.g., in refrigerated vehicles, the cooling circuit for the active cooling system of the computing unit can, however, also be connected to (a cooling circuit of) the (primary) cooling system or air-conditioning system of the vehicle.

However, in this embodiment as well, the control of the cooling system is typically not assumed by a vehicle computer used for controlling, regulating, and/or monitoring normal vehicle functions, or another manufacturer-provided controller of the vehicle.

Rather, the cooling system is typically controlled by a separate control computer for the computing unit, e.g., a single-board computer, such as a Raspberry Pi, which can be operated independently of the vehicle computer and is typically connected to a temperature sensor of the active cooling system, the fan, the pump, the computing unit, a temperature sensor of the computing unit, and/or a temperature sensor of the passive cooling system.

In addition, the control computer, which is typically likewise connected fixedly to the chassis, for the computing unit can serve for the communication with other computing nodes and/or with a server of a (distributed) network for crypto-mining via a radio module typically likewise connected fixedly to the chassis, and can serve to control the computing unit during the calculation (computuation) of the hashes.

However, the control computer can also be integrated into the computing unit.

The radio module can be a mobile radio module or a WLAN module, but also a different wireless telecommunications module for data transmission.

The communication with the other computing nodes or with the server of the network for crypto-mining can take place directly via the radio module, but also via a (further) radio module already installed by the vehicle manufacturer. For example, an Internet connection can be made via a wireless connection of the radio module (e.g., WLAN or Bluetooth) to a corresponding hotspot of the vehicle and, via the latter, to the further radio module (and thus into a mobile radio network).

According to one embodiment, an installation kit for a vehicle, in particular for a truck, a passenger car, a bus, or a rail vehicle, th kit comprises a computing unit for calculating hash values of a character string by means of a cryptographic hash function, and a liquid cooling system, installable in the vehicle, for the computing unit.

For reasons of efficiency, the computing unit is typically specially designed and/or even optimized for the calculation of the cryptographic hash function.

In particular, the computing unit can be designed as a hashboard, FPGA, or ASIC or have at least one of the elements mentioned. FPGA(s) or FPGA-based hashboard(s) are preferably used as computing unit, since they combine high calculation power and calculation efficiency (comparatively low energy demand) with high flexibility (e.g., for new calculation algorithms) and are thus, due to the expected long service life as well, particularly economical at least in the medium or long term and/or have a comparatively low ecological footprint.

In addition, the computing unit is typically configured to calculate the hash values at a hash rate of at least 10⁹ H/s, at least 10¹⁰ H/s, or even at least 10¹¹ H/s, and/or with a hash calculation efficiency of at least 10⁷ H/J, at least 10⁸ H/J, or even at least 10⁹ H/J, and/or hash values of a length of 256 bits or an integer multiple thereof.

In addition, the hash function can be an SHA hash function—in particular, an SHA-2 hash function.

Furthermore, the installation kit for the vehicle can have at least one, typically, several or even all of the following components:

installation instructions;

a control computer for the computing unit;

a power converter, which can be electrically connected to the electrical power supply of the vehicle, for the computing unit and/or the control computer;

a circuit breaker for an electrical connection between the electrical power supply and the power converter, the computing unit, and/or the control computer; and

a radio module, which can be connected to the computing unit and/or the control computer.

The liquid cooling system to be installed is typically a water cooling system.

In addition, the liquid cooling system can have a heat exchanger, at least one connecting hose, at least one fan, a coolant pump, a liquid valve, and/or a vibration damper for the respective fan.

Typically, the components of the liquid cooling system are selected such that the computing unit can be cooled during operation with a (variable) cooling capacity of a maximum of at least 100 W, at least 200 W, or even at least 500 W or 700 W.

Particularly for the operation in passenger cars, during the (mining) operation, the computing unit can have a maximum power consumption of 700 W, which can be exceeded by up to a maximum of, for example, 25% or 20% at the most for a short time, e.g., for a maximum of a few seconds, but not on average over time.

In addition, the cooling capacity of the liquid cooling system can have a cooling capacity, matched to the power consumption of the computing unit, of, for example, at least 700 W.

In addition, it can be provided that, in particular, the cables, plug connectors, or electrical connections, which are typically additionally present in the installation kit (set), be adapted (pre-assembled) not only to the computing unit to be installed, but also to a particular vehicle type. An analogous adaptation/pre-assembly can also be provided for the components of the liquid cooling system of the installation kit.

According to one embodiment, a method for installing the installation kit or for upgrading or retrofitting a vehicle, in particular, a truck, a passenger car, or a rail vehicle, the method comprises at least one of the following steps:

fastening, on and/or in the vehicle, a computing unit (described herein) for calculating hash values of a character string by means of a cryptographic hash function;

connecting the computing unit to an electrical power supply of the vehicle;

installing a liquid cooling system in the vehicle; and

connecting (fluidically) the computing unit to the liquid cooling system or to an existing circuit of the vehicle.

According to a further embodiment, a method for mining a block comprises the following steps:

receiving input data with a radio module of a vehicle;

transmitting the input data to a computing unit of the vehicle—typically, to a computing unit described herein; and

calculating, by the computing unit, a hash value of the input data by means of a cryptographic hash function.

The method can be carried out in particular while the vehicle is moving or with the engine running.

In addition, the method can include the steps of receiving selection data for the computing unit with the radio module, and/or using the selection data for selecting the cryptographic hash function prior to calculating the hash value of the input data. Thus, a computing unit configured to calculate hash values of the character string by means of several cryptographic hash functions can be made to calculate the hash value (typically, a plurality of hash values) with the hash function which appears most (economically) sensible under given circumstances.

It is understood that the selection data and input data can also be received together by the radio module.

In addition, the method can include the steps of receiving configuration data for the computing unit by means of the radio module and/or using the configuration data for (re)programming the computing unit. As a result, the typically FPGA-based, (multiply) (re)programmable computing unit can be configured to calculate hash values of character strings by means of a cryptographic hash function. This makes it possible to react with particular flexibility to current conditions (costs, achievable revenues).

The selection data, input data, and/or configuration data can be transmitted from a central station, e.g., a server, to the radio module.

In addition, the selection data, input data, and/or configuration data can be transmitted from the radio module to the control computer and forwarded (where applicable, revised and/or recoded/decrypted) by the latter to the computing unit. In particular, the control computer can be configured to cause a (re)programming of the computing unit.

The embodiments described above can be combined with one another as desired.

Further advantageous embodiments, details, aspects, and features of the present invention are apparent from the dependent claims, the description, and the accompanying drawings. Shown are:

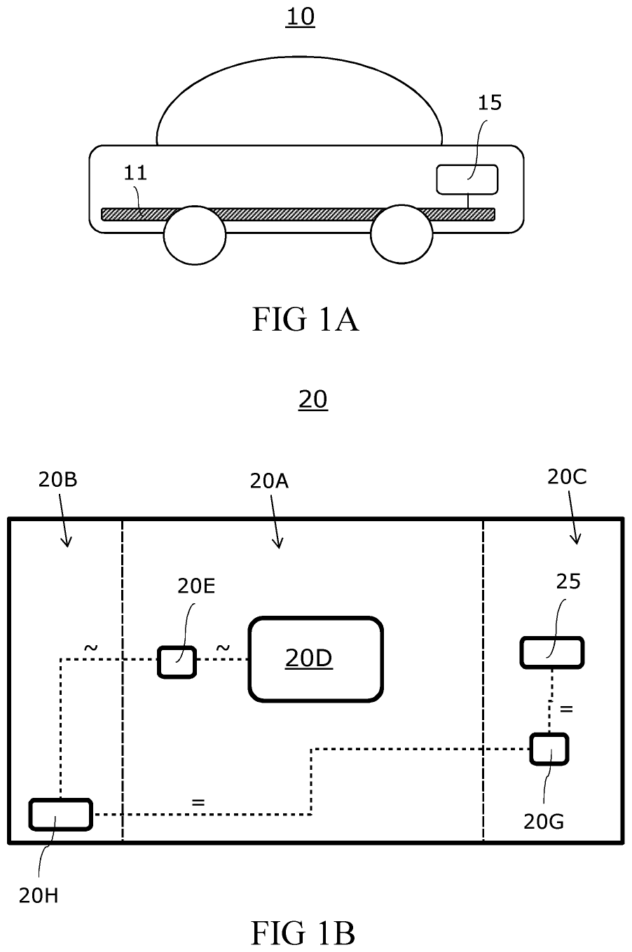

FIG. 1A a schematic view of a vehicle according to an exemplary embodiment;

FIG. 1B a schematic view of a vehicle according to an exemplary embodiment;

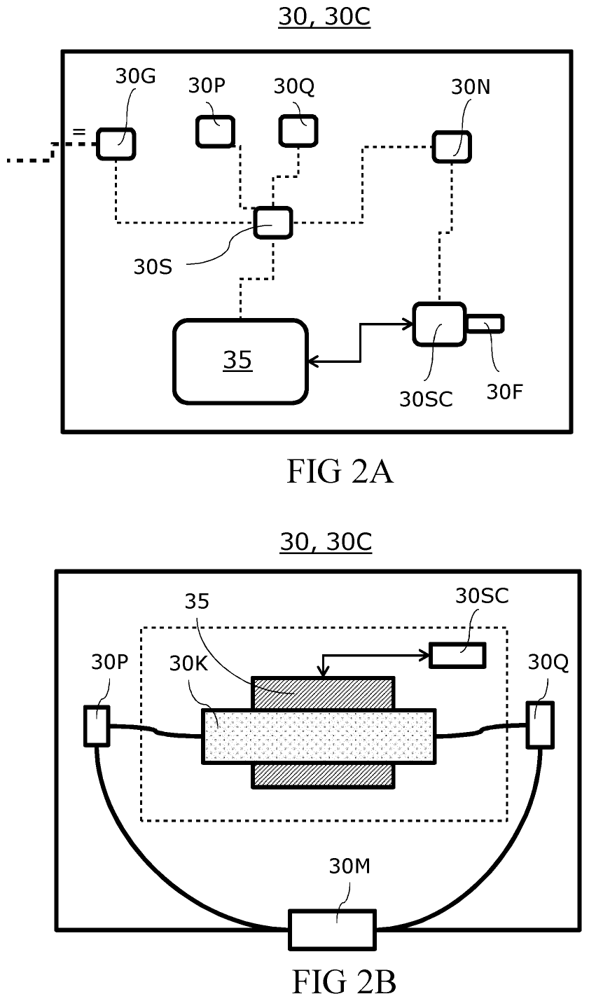

FIG. 2A a schematic view of a vehicle according to an exemplary embodiment; and

FIG. 2B a further schematic view of the vehicle shown in FIG. 2A according to an exemplary embodiment.

In the figures, the same reference signs, as well as reference signs that differ from one another only in the first character, denote similar parts, which may even be identical.

For reasons of simplicity, the further features of the device for mining and of the vehicle are typically explained in detail below only with respect to passenger cars. However, it is understood that other devices for mining can also have the explained further features.

FIG. 1A shows a schematic side view of a vehicle 10. The vehicle shown by way of example is a passenger car, e.g., a taxi, with a chassis 11 and a computing unit 15, which is typically indirectly but fixedly connected to the chassis 11 and which is designed to calculate a cryptographic hash function.

FIG. 1B shows a schematic top view of a vehicle 20 or of an electrical circuit diagram of the vehicle 20. The vehicle 20 is similar to the vehicle 10 explained above with reference to FIG. 1A. For reasons of clarity, a representation of the chassis in FIG. 1B and the following figures is omitted.

The exemplary embodiment is a hybrid vehicle 20, e.g., a Toyota Prius, like the car the author of the present document modified and used for mobile crypto-mining.

Accordingly, in a central vehicle section (central vehicle part) 20A, the vehicle 20 has an electrical power supply 20D, comprising a powerful battery, for the (temporary) electric driving of the vehicle 20. Such a battery is also referred to as a traction battery.

An advantage of hybrid vehicles in comparison to purely electrically-driven vehicles is that the vehicle battery 20D can be recharged by the existing internal combustion engine without having to interrupt the drive.

In addition, the vehicle 20 has a power converter 20H, which, for safety reasons, is connected via a first circuit breaker 20E to the electrical power supply 20D.

In FIG. 1B and the following figures, electrical connections for the power supply are shown as dashed lines. It is understood that an illustrated dashed line can correspond to a (single-wire, 2-wire, or multi-wire) cable, but also to several cables.

In the Toyota Prius, as also in other hybrid vehicles, the direct current from the traction battery is converted by an inverter (not shown in FIG. 1B) of the power supply 20D into three-phase alternating current for the driving of the electric motors. The inverter of the power supply 20D of the Toyota Prius does in fact contain a DC-DC converter, which supplies the 12-V battery and the standard motor-vehicle on-board power supply with electrical power. However, since the standard motor-vehicle on-board power supply could be at least temporarily overloaded by the crypto-mining, the computing unit 25 is not connected to the standard motor-vehicle on-board power supply or the 12-V battery, but is typically supplied via the power converter 20H designed as an AC-DC converter, which is connected via the first circuit breaker 20E to the three-phase AC connection of the power supply unit 20D (see also the “˜” and “=” symbols on the cables in FIG. 1B for DC and AC connections).

For safety reasons, a further circuit breaker 20G is also connected between the power converters 20H and the computing unit 25. It should be noted in this respect that a pair of circuit breakers can be used for each of the circuit breakers 20E and 20G.

The power converter 20H, which is also referred to as a power supply below, with, for example, 750 W power, can be fastened in a manner thermally well-decoupled from the computing unit 25, as already explained above, in the engine compartment 20B, e.g., in the vicinity of the fuse box. As a result, the requirements for the cooling system in the rear vehicle section 20C can be reduced.

FIG. 2A shows a schematic view from above of a rear section 30C of a vehicle 30 or of an electrical circuit diagram of the vehicle 30 in the rear section 30C.

The vehicle 30 is similar to the vehicle 20 explained above with reference to FIG. 1B. For example, the vehicle 30 can likewise be a Toyota Prius, of which FIG. 2A, again, only schematically shows the trunk or a lower part of the trunk.

In the exemplary embodiment of FIG. 2A, the supply with electrical power takes place via a distributor or plug 30S, which is connected to the circuit breaker 30G and may be a six-pin plug. Both the computing unit 35 and two coolant pumps 30P, 30Q and also a control computer 30SC are electrically supplied via the distributor 30S.

The control computer 30SC can, for example, be a Raspberry Pi—in particular, a Raspberry Pi 4—but also another (single-board) computer with low nominal power during operation of typically less than 10 W and/or low idle power of typically less than 4 W.

In contrast, the power consumption of the computing unit 35 is typically significantly greater during operation. It can be several hundred watts or even more. The author of the present application used an FPGA-based computing unit with a power consumption during the (mining) operation of a maximum of 700 W.

Due to the comparatively high power consumption of the computing unit 35, the latter can be connected via two pins/lines to the distributor 30S.

The connection, shown as a double arrow, between the computing unit 35 and the control computer 30SC can be a pure (bidirectional) data connection—in particular, a corresponding data cable (for example, a LAN cable).

Typically, the computing unit 35 has several computing subunits. The computing unit used by the author of the present document has a hashboard with several FPGA's, which can each execute one of the algorithms listed in the following table.

| | | |
|---|---|---|
| | | Power consumption of |
| Algorithm | Hash rate | the computing unit |

| | | | |
|---|---|---|---|
| Lyra2z | 53.0 | MH/s | 590 W |
| Skein | 5.04 | GH/s | 423 W |
| Lyra2REv2 | 216.0 | MH/s | 334 W |
| Phil612 | 314.0 | MH/s | 558 W |
| Tribus | 2.8 | GH/s | 607 W |
| Nexus | 2.45 | GH/s | 550 W |
| BCX | 16.56 | GH/s | 474 W |
| 0xtoken | 21.12 | GH/s | 605 W |
| Keccak | 21.12 | GH/s | 605 W |
| Xdag | 14.7 | GH/s | 609 W |
| ZP | 22.0 | GH/s | 610 W |
| VerusHash 1.0 | 64.8 | GH/s | 237 W |
| Keccakc | 21.12 | GH/s | 605 W |
| Keccakd | 21.12 | GH/s | 605 W |
| Amoveo | 46.0 | GH/s | 570 W |
| Veriblock | 11.5 | GH/s | 600 W |
| Sha3d | 9.1 | GH/s | 605 W |
| Verus2 | 272.0 | MH/s | 219 W |
| BCD | 178.0 | MH/s | 462 W |
| Lyra2rev3 | 240.0 | MH/s | 540 W |
| DigiByte (odocrypt) | 3.52 | GH/s | 620 W |
| Bmw512 | 8.78 | GH/s | 328 W |
| C11 | 0.152 | GH/s | 404 W |
| BST | 18.0 | GH/s | 600 W |
| K12 | 43.2 | GH/s | 626 W |

According to the hash rates and the electrical power consumptions specified in the above table, revenues of approximately $9 per day can currently be achieved, for example, by digging for the crypto-currency, “Denarius Coin,” with the implemented Tribus algorithm, and thus a profit of about €5 per day can be achieved with a Toyota Prius at the current exchange rates and the fuel prices in Germany.

In addition to the hashboard, the computing unit 35 can also have a motherboard, which is connected via the data cable to the control computer 30SC and via a further data cable to the actual hashboard.

The motherboard may serve the communication between the control computer 30SC and the hashboard. In addition, the motherboard can monitor important information, such as chip temperatures or hashboard temperatures, and can forward error messages and connections to the crypto-mining pool.

In addition, a USB stick 30F (including SIM card) as a radio module for the desired Internet connection can be connected to the control computer 30SC. In this embodiment, a separate power supply of the radio module is omitted.

As further illustrated in FIG. 2A, the control computer 30SC can be connected via a power supply (e.g., a DC-DC voltage converter from 12 V to 5 V) to the distributor 30S.

By means of long-term tests, it was possible to determine that, with the selected structure, additional income (revenues minus additional fuel costs) in the amount of approximately $9 per day in the form of crypto-currencies can be achieved on average during a daily operating time of the Toyota Prius of approximately 12 hours per day.

FIG. 2B shows a schematic top view of the rear section 30C of the vehicle 30, which illustrates both the structure and the cooling system of the computing unit 35.

As illustrated by the dashed quadrilateral in FIG. 2B, the computing unit and the control computer 30SC can be accommodated in a common housing and be mechanically fixedly connected via the latter to the bottom of the (lower section) of the trunk. For example, the housing can be fastened with one or more screw connections.

In the exemplary embodiment illustrated in FIG. 2B, the computing unit is provided on its upper side with a cooling element 30K, which is typically in good thermal contact/good thermal connection with the powerful calculation units (for example, ASIC's or typical FPGA's).

The cooling element 30K can be one, but also several, cooling blocks through which liquid can flow.

The cooling block 30K illustrated by way of example is connected via hoses, illustrated as thick curves, and two coolant pumps 30P, 30Q to a cooler 30M.

In this case, it can be provided that one hose, but also two hoses, lead from each pump 30P, 30Q to the cooling element 30K.

However, the cooling circuit formed can also have only one coolant pump.

The cooler 30M can be designed as a cooling module or radiator and/or can be mounted between the rear bumper and the body of the vehicle. There, the cooler 30M is exposed to particularly good air circulation and also protected against water from below.

Despite the good air circulation during the drive, the cooler 30M can be equipped with one or two fans, or even more fans. In this way, a good cooling capacity can be ensured, even during standstill of the vehicle and/or at comparatively high outside temperatures.

A respective vibration damper is typically arranged between the body and the fan(s). In this way, a (perceptible or audible) vibration excitation of the body or of the vehicle frame by the cooler 30M can be at least largely avoided.

For example, the cooler 30M can have two rows of fans, e.g., with in each case 2 to 4 fans, between which the cooling element, through which liquid can flow, is arranged with its lamellae. This design of the cooler 30M (when arranged between the body and the bumper) has proven to be particularly effective in long-term experiments.

In particular, water, or a mixture of water and an antifreezing agent, can be used as the coolant.

In addition, it can be provided that the housing of the computing unit 35 have air openings and/or fans for generating or assisting air convection in the housing and/or an air flow through the housing. This can assist the liquid cooling system.

The control of the cooling system of the computing unit 35 can be assumed, for example, by the control computer 30SC, which receives temperature data from the motherboard for this purpose. For reasons of clarity, a representation of the data connection or the connections between the interfaces of the control computer 30SC and the pumps 30P and 30Q in FIG. 2B has been omitted.

The present invention has been explained with reference to exemplary embodiments. These exemplary embodiments should in no way be understood as restrictive for the present invention. The following claims represent a first, non-binding, attempt to define the invention in general.

### LIST OF REFERENCE SIGNS

10, 20, 30 Vehicle, device for crypto-mining
11 Frame, chassis
15, 25, 35 Computing unit, hashboard
20A Central vehicle section/central vehicle part
20B Front vehicle section/front vehicle part/engine compartment
20C, 30C Rear vehicle section/rear vehicle part/trunk
20D Electrical energy store/vehicle battery
20E, 20G, 30G Circuit breaker
20H Power converter
30K Cooling element
30F (Mobile) radio module/USB surfstick
30M Heat exchanger/cooler/fan
30N (Adjustable) power supply
30P, 30Q Pump
30S Distributor/(6-pin) plug
30SC Control computer (e.g., Raspberry Pi)

1-52. (canceled)

53. A device for mining, comprising:
a computing unit for calculating hash values of a character string by means of a cryptographic hash function, wherein the computing unit is configured to calculate the hash values at a hash rate of at least 10⁹ H/s and/or a hash calculation efficiency of at least 10⁷ H/J;
an electrical power supply to which the computing unit is electrically connectable; and
a frame to which the computing unit and the electrical power supply are fixedly connected,
wherein the device is designed for the transport of an additional payload.

54. A device according to claim 53, wherein the device is a motorized vehicle, wherein the device is a rail vehicle or a motor vehicle, in particular a truck, a bus, or a passenger car, in particular, a taxi, a rental vehicle, and/or a car-sharing vehicle, and/or wherein the electrical power supply comprises an electrical energy storage device, in particular a vehicle battery and/or a traction battery, wherein the hash rate is at least 10¹⁰ H/s or even at least 10¹¹ H/s, wherein the hash calculation efficiency is at least 10⁸ H/J or even 10⁹ H/J, wherein the hash values have a length of 256 bits or an integer multiple thereof, wherein the hash function is an SHA hash function, in particular an SHA-2 hash function, wherein the computing unit has a power consumption of a maximum of 700 W and/or can be reprogrammed, wherein the computing unit is specially designed and/or even optimized for the calculation of the cryptographic hash function, wherein the computing unit is designed and/or even optimized for the calculation of several cryptographic hash functions, wherein the computing unit has several computing subunits configured to execute an algorithm for calculating the respective cryptographic hash function, wherein the computing subunits are arranged on one, two, or even more hashboards, wherein the computing unit further comprises a motherboard, wherein the computing unit is electrically connectable to the electrical power supply via a circuit breaker and/or a power converter, and/or wherein the computing unit is connected to the frame directly or indirectly, e.g., via a body of the device.

55. A device according to claim 53, wherein the computing unit comprises an FPGA.

56. A device according to claim 53, wherein the computing unit comprises a hashboard and/or an ASIC.

57. A device according to claim 54, wherein the respective computing subunit comprises at least one of an FPGA and an ASIC.

58. A device according to claim 54, wherein the power converter is arranged in a first part of the vehicle, in particular, in an engine compartment of the vehicle, and/or wherein the computing unit is arranged in a second part, spaced apart from the first part, of the vehicle, in particular, in a storage space, e.g. in a trunk, in particular in a lower part of the trunk or underneath the trunk.

59. A device according to claim 53, further comprising at least one of:
a passive cooling system, connected to the computing unit,
an active cooling system connected to the computing unit,
a motor, connected to the frame for driving the device, in particular an internal combustion engine and/or an electric motor, and
a cooling unit for the motor, the cooling unit typically being fluidically separated from the active cooling system.

60. A device according to claim 59, wherein the active cooling system comprises a liquid cooling system, in particular, a water cooling system, a heat exchanger, a coolant pump, and/or a fan, the fan typically being connected via a vibration damper to the body and/or the frame, and/or wherein the liquid cooling system comprises a cooling capacity of at least 100 W, at least 200 W, or even at least 500 W or 700 W.

61. A device according to claim 53, wherein the frame is designed for an additional load of at least 100 kg, at least 500 kg, or even at least 1,500 kg.

62. A device according to claim 53, wherein the vehicle comprises at least one of:
a vehicle computer for controlling, regulating, and/or monitoring vehicle functions, and wherein the computing unit is operable independently of the vehicle computer;
a control computer for the computing unit; and
a radio module connected to the computing unit and/or to the control computer.

63. A vehicle comprising:
a chassis; and
a computing unit fixedly connected to the chassis, the computing unit comprising a hash rate of at least 10⁹ H/s and/or a hash calculation efficiency of at least 10⁷ H/J for calculating a cryptographic hash function.

64. A vehicle according to claim 63, wherein the vehicle comprises an electrical energy supply, in particular an electrical energy storage, typically a vehicle battery and/or a traction battery, wherein the computing unit is electrically connectable to the electrical energy supply, wherein the computing unit is specially designed and/or even optimized for the calculation of the cryptographic hash function, wherein the computing unit is designed and/or even optimized for the calculation of several cryptographic hash functions, wherein the computing unit has a hashboard, wherein the computing unit has several computing subunits configured to execute an algorithm for calculating the respective cryptographic hash function, and/or wherein the computing subunits are arranged on one, two, or even more hashboards, wherein the hash rate is at least 10¹⁰ H/s or even at least 10¹¹ H/s, wherein the hash calculation efficiency is at least 10⁸ H/J or even 10⁹ H/J, wherein the hash values correspond to a length of 256 bits or an integer multiple thereof, and/or wherein the hash function is an SHA hash function, in particular an SHA-2 hash function.

65. A vehicle according to claim 63, wherein the computing unit comprises at least one of an FPGA and an ASIC.

66. A vehicle according to claim 63, wherein the computing unit is electrically connectable to the electrical power supply via a circuit breaker and/or a power converter, wherein the power converter is typically arranged in a first part of the vehicle, in particular in an engine compartment of the vehicle, wherein the computing unit is arranged in a second part, spaced apart from the first part, of the vehicle, in particular in a storage space, e.g. in a trunk, in particular in a lower part of the trunk or underneath the trunk, and/or wherein the vehicle is a rail vehicle or a motor vehicle, in particular a truck, a bus, or a passenger car, in particular, a taxi, a rental vehicle, and/or a car-sharing vehicle.

67. A vehicle according to claim 63, wherein the vehicle is a hybrid vehicle.

68. A vehicle according to 63, wherein the vehicle comprises at least one of;
a vehicle computer for controlling, regulating, and/or monitoring vehicle functions, and wherein the computing unit is operable independently of the vehicle compute;
a body via which the computing unit is connected to the chassis;
a passive cooling system connected to the computing unit;
an active cooling system connected to the computing unit;
a cooling unit for a drive motor of the vehicle, the cooling unit typically being fluidically separated from the active cooling system;
an air-conditioning unit for an interior of the vehicle, air-conditioning unit typically being fluidically separated from the active cooling system;
a control computer for the computing unit; and
a radio module connected to the computing unit and/or to the control computer.

69. A vehicle according to claim 68, wherein the active cooling system comprises a liquid cooling system typically designed as a water cooling system, a heat exchanger, a coolant pump, and/or one or more fans, wherein the heat exchanger, the coolant pump, and/or at least one of the fans are arranged neither in the first part nor in the second part of the vehicle, in particular, at least partially in an outer region of the vehicle, typically between a rear bumper and the vehicle frame of the vehicle, wherein the liquid cooling system comprises a cooling capacity of at least 100 W, at least 200 W, or even at least 500 W or 700 W, and/or wherein the fan is connected via a damper to the vehicle frame.

70. An installation kit for a vehicle, in particular a truck, a passenger car, or a rail vehicle, the kit comprising:
a computing unit for calculating hash values of a character string by means of a cryptographic hash function; and
a liquid cooling system, which can be installed in the vehicle, for the computing unit.

71. An installation kit according to claim 70, wherein the computing unit is specially designed and/or even optimized for the calculation of the cryptographic hash function, wherein the computing unit is designed and/or even optimized for the calculation of several cryptographic hash functions, wherein the computing unit comprises a hashboard, an FPGA, and/or an ASIC, wherein the computing unit comprises several computing subunits configured to execute an algorithm for calculating the respective cryptographic hash function, wherein the respective computing subunit comprises an FPGA and/or an ASIC, wherein the computing subunits are arranged on one, two, or even more hashboards, wherein the computing unit is configured to calculate the hash values at a hash rate of at least 10⁹ H/s, at least 10¹⁰ H/s, or even at least 10¹¹ H/s, and/or with a hash calculation efficiency of at least 10⁷ H/J, at least 10⁸ H/J, or even at least 10⁹ H/J, and/or wherein the hash values have a length of 256 bits or an integer multiple thereof, and/or wherein the hash function is an SHA hash function, in particular, an SHA-2 hash function.

72. An installation kit according to claim 70, further comprising at least one of:
installation instructions;
a fastening means for fastening the computing unit on and/or in the vehicle;
a control computer for the computing unit, the control computer typically comprising a nominal power during operation of less than 10 W and/or an idle power of less than 4 W;
a power converter, which can be electrically connected to an electrical power supply of the vehicle, for the computing unit and/or the control computer;
a circuit breaker for an electrical connection between the electrical power supply and the power converter, the computing unit, and/or the control computer; and
a radio module, which can be connected to the computing unit and/or the control computer.
